(19) United States
(12) Patent Application Publication
(10) Pub. No.: US 2012/0272156 A1
(43) Pub. Date: Oct. 25, 2012

(54) LEVERAGING CONTEXT TO PRESENT CONTENT ON A COMMUNICATION DEVICE

(76) Inventors: Kameron N. KERGER, San Diego, CA (US); Jonathan K. KIES, Encinitas, CA (US)

(21) Appl. No.: 13/092,418

(22) Filed: Apr. 22, 2011

(51) Int. Cl. G06F 3/01

(52) U.S. Cl. 715/747

(57) ABSTRACT

A communication device or handset presents a contextual catalog of content items to enhance mobile shopping user experience, mitigating display limitations for generally large content catalogs. Contextual information available on the handset, such as Global Positioning System (GPS) location or other readable parameters, can be used to determine unique, relevant categories, content or offers, for displaying through a user interface. Categories such as ‘local’ can be generated on-the-fly using GPS for a personalized content browsing experience. Additional context such as knowing that the user and device are rarely in a location (e.g., specific neighborhood, particular city, or country) can be used to generate unique price plans (such as day passes) that the user can use when travelling.

### BACKGROUND

The present disclosure relates to a mobile operating environment, and more particularly, to providing improved apparatus and methods of distributing content including recommendations for goods and services to computer devices.

Mobile operators or wireless network carriers play a major part in the telecommunication industry today. Initially, such mobile operators concentrated their efforts on generating revenue by increasing their subscriber base. However, it will be appreciated that in several countries the scope for increasing the subscriber base has now become very limited, as the market has reached close to the saturation point. As a result, the mobile operators have been branching into providing value added services to subscribers, in order to increase their revenue.

One means of generating increased revenue is through the sales of premium services to users, such as ringtones, wallpaper, games, etc. These services may be provided by the mobile operator themselves, or by business entities who may operate in collaboration with the mobile operators to provide such services. The services may be available for download to a user's communication device upon payment of a fee.

Many benefits such as maximizing the potential earnings for sales may accrue upon recommending and promoting to users content or services that are the most likely to be of interest to the users. The user can have a better experience using their communication device in light of these individually recommended content and services.

A burgeoning area of such content and services pertains to applications. For example, an on-device mobile application store has become a crowded, hard-to-browse experience as more and more applications come online. What users need is a way to discover new content that is easy to use, hopefully fun, and yet still relevant. One way to solve this problem is through an application recommendation system. This can work, but typical application recommendation systems are based on an aggregated “average” of user behavior and preferences. Such recommendations can be wholly unsuited to users with particular skill sets and interests that differ from the norm.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, the present disclosure provides a method for presenting individualized content on a communication device by determining a physical context of a communication device, associating a user context with the communication device based upon a prior interaction with the communication device, selecting a content item that corresponds to the physical context and the user context, and presenting the content item on a user interface of the communication device.

In another aspect, the present disclosure provides at least one processor for presenting individualized content on a communication device. A first module determines a physical context of a communication device. A second module associates a user context based upon a prior interaction with the communication device. A third module selects a content item that corresponds to the physical context and the user context. A fourth module presents the content item on a user interface of the communication device.

In an additional aspect, the present disclosure provides a computer program product for presenting individualized content on a communication device. A non-transitory computer-readable medium stores sets of instructions. At least one instruction causes a computer to determine a physical context of a communication device. At least one instruction causes the computer to associate a user context with the communication device based upon a prior interaction with the communication device. At least one instruction causes the computer to select a content item that corresponds to the physical context and the user context. At least one instruction causes the computer to present the content item on a user interface of the communication device.

In a further aspect, the present disclosure provides an apparatus for presenting individualized content on a communication device. The apparatus comprises means for determining a physical context of a communication device. The apparatus comprises means for associating a user context with the communication device based upon a prior interaction with the communication device. The apparatus comprises means for selecting a content item that corresponds to the physical context and the user context. The apparatus comprises means for presenting the content item on a user interface of the communication device.

In yet another aspect, the present disclosure provides an apparatus for presenting individualized content on a communication device. A content presentation component determines a physical context of a communication device, associates a user context based upon a prior interaction with the communication device, and selects a content item that corresponds to the physical context and the user context. A user interface of the communication device presents the content item.

In yet an additional aspect, the present disclosure provides a method for suggesting individualized content for a communication device by receiving a communication from the communication device, determining a physical context of a communication device in response to the communication, associating a user context with the communication device based upon a prior interaction with the communication device, selecting a content item that corresponds to the physical context and the user context, and transmitting the content item to the communication device for presenting on a user interface.

In another aspect, the present disclosure provides at least one processor for suggesting individualized content for a communication device. A first module receives a communication from the communication device. A second module determines a physical context of a communication device in response to the communication. A third module associates a user context based upon a prior interaction with the communication device. A fourth module selects a content item that corresponds to the physical context and the user context. A fifth module transmits the content item to the communication device for presenting on a user interface.

In an additional aspect, the present disclosure provides a computer program product for suggesting individualized content for a communication device. A non-transitory computer-readable medium stores sets of instructions. At least one instruction causes a computer to receive a communication from the communication device. At least one instruction causes the computer to determine a physical context of a communication device in response to the communication. At least one instruction causes the computer to associate a user context with the communication device based upon a prior interaction with the communication device. At least one instruction causes the computer to select a content item that corresponds to the physical context and the user context. At least one instruction causes the computer to transmit the content item to the communication device for presenting on a user interface.

In a further aspect, the present disclosure provides an apparatus for suggesting individualized content for a communication device. The apparatus comprises means for receiving a communication from the communication device. The apparatus comprises means for determining a physical context of a communication device in response to the communication. The apparatus comprises means for associating a user context with the communication device based upon a prior interaction with the communication device. The apparatus comprises means for selecting a content item that corresponds to the physical context and the user context. The apparatus comprises means for transmitting the content item to the communication device for presenting on a user interface.

In yet a further aspect, the present disclosure provides an apparatus for suggesting individualized content for a communication device. A network interface receives a communication from the communication device. A content presentation component determines a physical context of a communication device in response to the communication, associates a user context based upon a prior interaction with the communication device, and selects a content item that corresponds to the physical context and the user context. The network interface further transmits the content item to the communication device for presenting on a user interface.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 illustrates a schematic diagram of an aspect of a communication system for presenting individualized content according to a context and an operating constraint of a communication device.

FIG. 2 illustrates a functional diagram of an aspect of inputs to a determined context.

FIG. 3 illustrates a flow diagram for an aspect of a methodology performed by a computer device or communication device for presenting individualized content on a communication device.

FIG. 4 illustrates a flow diagram for an aspect of a methodology performed by a network device for providing individualized content to a computer device or communication device.

FIG. 5 illustrates a timing diagram for an aspect of a methodology for presenting individualized content on a computer device or communication device with filtering performed by a network device.

FIG. 6 illustrates a timing diagram for an aspect of a methodology for presenting individualized content on a communication device with filtering performed by the computer device or communication device.

FIG. 7 illustrates a flow diagram for an aspect of a methodology for presenting individualized content on a computer device or communication device according to context based upon device physical characteristics, user identity, demographics, and user behavior.

FIG. 8 illustrates an aspect of a graphical user interface of a computer device or communication device with a context of location enhancing a local screen.

FIG. 9 illustrates an aspect of the graphical user interface of the computer device or communication device with a context of location enhancing a weather screen.

FIG. 10 illustrates an aspect of the graphical user interface of the computer device or communication device with a context of location enhancing a travel screen.

FIG. 11 illustrates an aspect of the graphical user interface of the computer device or communication device with a context of location enhancing a search results screen.

FIG. 12 illustrates an aspect of the graphical user interface of the computer device or communication device with a context of channel quality enhancing a productivity screen.

FIG. 13 illustrates an aspect of the graphical user interface of the computer device or communication device with a context of time of day enhancing a contact list screen.

FIG. 14 illustrates a schematic block diagram of an aspect of a system residing at a computer device or communication device of logical groupings of electrical components for presenting individualized content according to context.

FIG. 15 illustrates a schematic block diagram of an aspect of a system residing at a network device of logical groupings of electrical components for presenting individualized content according to context.

FIG. 16 illustrates a schematic block diagram of an aspect of a system for presenting individualized content according to context.

FIG. 17 illustrates a schematic block diagram of an aspect of an apparatus, including a computer device or communication device, for presenting individualized content according to context.

### DETAILED DESCRIPTION

In accordance with one or more aspects and corresponding disclosure thereof, apparatus and methods are described in connection with a contextual catalog of content items that can be used by a communication device to enhance a mobile shopping user experience. Content catalogs on computer devices or communication devices are often overwhelming to the user, as such content catalogs may include very large (e.g., hundreds, thousands, etc.) listings of available content. Contextual information available on the communication device, such as Global Positioning System (GPS) location information or other detectable or obtainable parameters, can be used to determine unique, relevant categories, content or offers, for displaying through a user interface. Categories such as ‘local’ can be generated on-the-fly using location information for a personalized content browsing experience related to where a communication device is located. Additional context, such as historical user behavior information, may allow additional content catalog customization. For example, the historical user behavior information may allow a determination that the user and device are rarely in a location (e.g., specific neighborhood, particular city, or country), and such a determination may be the basis for presenting unique price plans (such as day passes) that the user can use when travelling.

Other contexts, such as historical information relating to user behavior or user interaction with the communication device, such as a volume of use, could be used to suggest a category of content (e.g., an application) appropriate to that level of use. For example, some applications can be particularly relevant to a novice user who has not discovered certain functional capabilities of the communication device. Alternatively, an expert user can be determined to be suitable for recommending or presenting an application having advanced features beyond those available through applications currently residing on the communication device. For instance, a photograph organization application can be appropriate for a heavy camera user.

Another context may be related to a physical characteristic of a component of the device, such as a low battery power level or a weak received communications signal, which could prompt a suggestion from the store, for example, a ‘battery boosting’ application or a Wi-Fi hotspot finder, respectively.

Using meta data and communication device applications, the vast array of mobile content and services can be specifically tailored to the current context and device capability of the communication device and end user. For example, when requested during interaction with a content server or store, the communication device could send any number of current contexts to the content server or store for tailoring of content suitable to propose to the communication device and the user.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

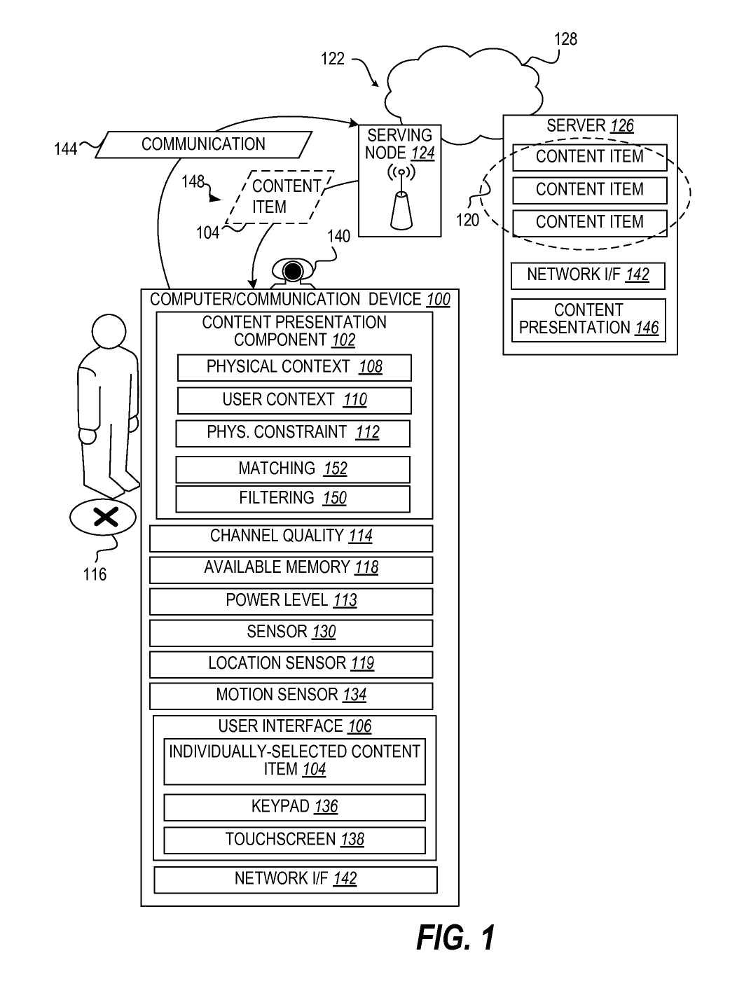

With initial reference to FIG. 1, an apparatus, depicted as a computer device or communication device 100, includes a content presentation component 102 that may present an individually-selected content item 104 on a user interface 106 according to at least a physical context 108 and/or a user context 110, and optionally further according to a physical constraint 112 of the communication device 100. Thereby, the content presentation component 102 ensures that the content item 104 is relevant to or personalized for the user based upon the physical context 108 and/or the user context 110.

Although communication device 100 is depicted in an exemplary aspect to demonstrate physical context 108 may include location and movement related information, it should be appreciated with the benefit of the present disclosure that certain aspects disclosed herein have application to a stationary computer device or communication device.

In an aspect, the physical context 108 can be a temporary state of the communication device 100. For example, the content presentation component 102 of the communication device 100 can determine the physical context 108 of the communication device 100, to include information such as, but not limited to, a power level 113 of a device power source, such as a battery, being below a power level threshold, a quality of an air link or channel quality 114 relative to a channel quality threshold, a type of a Radio Access Technology (RAT) provided by a serving node 124, an amount of available memory 118, a current location 116 based upon a location sensor 119, etc. One physical context 108 or a combination of more than one physical context 108 can limit the individually-selected content item(s) 104 to a subset of available content items 120, e.g. from a content server 126, that would be suitable or recommended.

The content presentation component 102 can correlate the physical context 108 with the user context 110, the latter having been refined over a period of time by monitoring prior interactions with the user interface 106 to target the individually-selected content item 104 among a range of possible candidates. For example, prior interactions with the user interface 106 can identify a level of expertise, interests, preferences, etc., one or more of which may define the user context 110.

In one aspect, the content presentation component 102 is largely or entirely autonomous for at least certain periods of time, drawing upon monitoring of physical context 108, tracking the user context 110, and selecting from among locally-available ones of the content items 120, each function provisioned on and executed by the communication device 100.

Alternatively or in addition, one or more of the functions or data repositories that comprise the content presentation component 102 may be distributed between the communication device 100 and one or more components of a communication network 122. For instance, the available content items 120 may be accessed by communication device 100, via a serving node 124, from the content server 126 via a core network 128, such as the Internet.

In one aspect, one or more sensor(s) 130 detect information that may be used to define the physical context 108 of the communication device 100 or the user context 110. For example for defining the physical context 108, one or more sensor(s) 130 may include the location sensor 119, which may determine a location of the communication device 100. Further, for example for defining the physical context 108, one or more sensor(s) 130 may include a motion sensor 134, which may detect motion indicative of an activity (e.g., pedestrian walking, riding on ground transportation, etc.), especially if correlated with location sensing.

Similarly, for example for defining the user context 110, one or more sensor(s) 130 may include a keypad 136 of the user interface 106, which may detect user alphanumeric inputs. As a further example for defining the user context 110, one or more sensor(s) 130 may include a touchscreen 138, which may detect a user's finger size or fingerprint. As yet another example for defining the user context 110, one or more sensor(s) 130 may include a webcam 140, which may recognize a user's face or expression.

Thus, in one aspect, the communication device 100 defines an apparatus for presenting individualized content. The content presentation component 102 determines the physical context 108 of the communication device 100, associates the user context 110 with the communication device 100, based upon a prior user interaction with the communication device 100, and selects the content item 104 from among a plurality of content items, e.g. content items 120, that corresponds to the physical context 108 and the user context 110. Thereby, content item 104 is personalized or customized based on context information, and the user interface 106 can present the content item 104.

Alternatively or in addition, the content server 126 defines an apparatus for suggesting individualized content for the communication device 100. In an aspect, for example, a network interface 142 of the content server 126 receives a communication 144 from the communication device 100 via the serving node 124. A network content presentation component 146 can determine or be informed of the physical context 108 of the communication device 100 in response to the communication 144. Further, the network content presentation component 146 can obtain the user context 110 based upon a prior interaction with the communication device 100. The network content presentation component 146 can select the content item 104 that corresponds to the physical context 108 and the user context 110. The network interface 142 further can transmit the content item 104, as depicted at 148, to the communication device 100 for presenting on the user interface 106.

In one aspect, the communication device 100 can present individualized content by using a filtering component 150 and a matching component 152 according to context. Inputs are accessed or determined, depicted as device physical characteristics, user identity and demographics, and user behavior. Context is determined from these inputs. The resulting context can be used to filter applicable entries in a category listing. The presentation of the filtered categories can further be modified (e.g., sorting, segregating, categorizing, etc.). For example, the more applicable content items or categories can be made prominent in a resulting context-specific catalog.

For clarity, the content presentation component 102 is depicted as integral to the communication device 100 as well as an array of components and functionalities of the communication device 100 that can be a source of physical context information or user context information. It should be appreciated with the benefit of the present disclosure that certain implementations can omit certain components or functionalities or accomplish a similar effect by a distributed or remote process.

For example, a user can carry a personal access network with various Machine-to-Machine (M2M) communication devices, such as medical or physical training monitors, an entertainment or gaming device, as well as a smartphone. Alternatively or in addition, a home network of the user can be a source of physical context information or user context information as well as serving as a means of distributed processing. Collaboration between the devices can accomplish certain features as described herein.

The present disclosure thereby discloses fostering a relationship between the consumer and the content as facilitated by an operator. By leveraging valuable network assets such as location and user activity, operators can help tailor and deliver contextual content to consumers. The combination of customer intelligence and network information enables the right message to reach the right consumer at the right time, resulting in a valued service that engenders ongoing loyalty. The operator is able to deliver a consumer experience that is always personal, regardless of how, when or where a person chooses to access their content. Contextual content can be driven by factors such as social networking and sharing, location awareness, and subscriber intelligence (e.g., preferences, profiles, past behavior, etc.).

For example, a profile and recommendation system can enable mobile operators of a wireless communication network and their business partners to proactively promote the uptake of content and services to their subscriber base of communication devices used by subscribers. In one example, this is achieved by the generation of a list of recommended content tailored for the particular subscriber for delivery to their communication device. According to one aspect, stored profile data comprises attribute data or behavior data. A corresponding plurality of recommenders, such as an attribute recommender and a behavior recommender associate the respective data with a content characterization cross reference of a catalogue index of content. Preliminary recommendations from the recommenders can have a confidence level assigned by a confidence weighting component. For example, a weak or strong association may be determined As another example, an attribute or behavior may be weakly determined through inferential analysis of limited occurrences or be strongly determined through explicit inputs or repeated behaviors.

For example, an association can be made for a user with an attribute based on peer-to-peer (P2P) relationship with a user for whom the attribute was previously determined This indirect association can have a lower weighting than an association made from express or direct information. A user can be associated with a group, such as explicit enrollments, frequent accessing of a portal for a group, etc. This associated group can have attribute and behavior data that can then be used for the associated user, especially in instances where insufficient data has been received specific to the associated user.

The weighted preliminary recommendations can then be sorted by a sorting component. Prior or subsequent to sorting, a filtering component implements an exclusion to avoid an inappropriate recommendation. Exclusions can be expressly specified by the subscriber, such as restricting certain categories of recommendations that would be objectionable. Exclusions can be specified by the mobile operator, such as specifying computing platform targets suitable for the content (e.g., audio files suitable for a communication device with an MP3 media player). Exclusions can also be drawn from profile data, such as tracking of purchases of content that would otherwise be recommended again or recommendations repeatedly ignored by the subscriber. Exclusions can also be drawn from content providers, which can be the mobile operator, by providing device or software configuration compatibility information. Thereby, communication devices that cannot successfully use recommended content are excluded.

The recommendations are generated by an analysis of the subscriber information available to the mobile operator in conjunction with the content and services offered, so as to determine those content and services, which are likely to be of the most interest to the subscriber. In particular, the profile and recommendation system also enables the recommendations to be delivered to the subscriber at those times which have been determined to be when the subscriber is most amenable to purchasing based on attribute or behavior assessment as an individual or group member. The profile and recommendation system is also adapted to generate promotions, when it is desired to actively promote a particular content or service to its subscriber base.

Identifying particular content can be facilitated by use of metadata. Metadata is defined as data providing information about one or more aspects of the content, such as means of creation of the content, purpose of the content, time, and date of creation, creator, or author or source of the content, placement on a computer network where the content or offering for the content was created, and standards used. The Metadata can provide a hierarchical taxonomy for cataloging content or more of a free form or folksonomy for categorizing content.

It should be appreciated that metadata as applied to content can have one or more aspects or functionalities that can be leveraged for matching and filtering. For instance, guide metadata can be intended to help humans find specific items and is usually expressed as a set of keywords in a natural language. Descriptive metadata is the information used to search and locate an object such as title, author, subjects, keywords, publisher. Structural metadata gives a description of how the components of the object are organized. Administrative metadata refers to the technical information including file type and can relate to rights management metadata and preservation metadata. Hierarchical, linear and planar schemata can be used. Metadata schemas can be hierarchical in nature where relationships exist between metadata elements and elements are nested so that parent-child relationships exist between the elements. Metadata schemas can also be one dimensional, or linear, where each element is completely discrete from other elements and classified according to one dimension only. Metadata schemas are often two dimensional, or planar, where each element is completely discrete from other elements but classified according to two orthogonal dimensions.

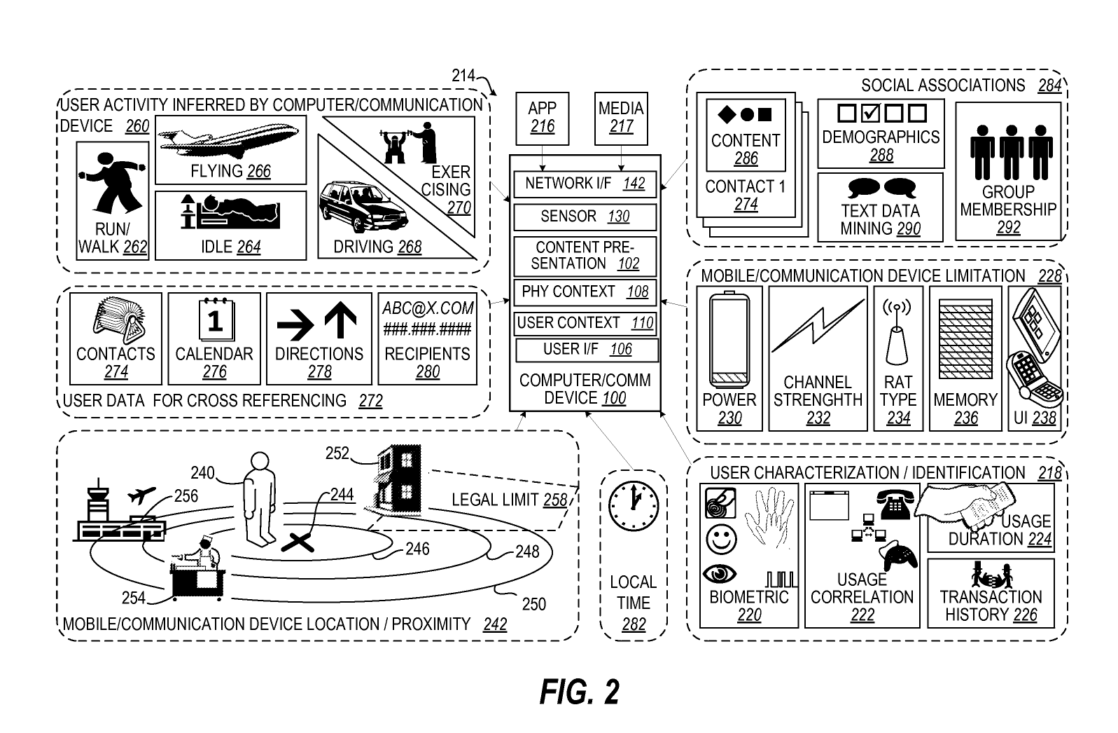

FIG. 2 is a schematic representation of various inputs that may be determined or obtained by the device to determine physical and user contexts, which are then used to obtain a subset of content that matches these contexts. In FIG. 2, a communication device 100 can have a content presentation component 102 that can determine a physical context 108 of the communication device 100 and can ascertain a user context 110. Sensor(s) 130 can detect the physical context 108. A user interface 106 can be monitored by the content presentation component 102 for interactions to denote or connote aspects of the user context 110. A network interface 142 can facilitate a distributed form of the content presentation component 102. Alternatively or in addition, the network interface 142 can receive content items 214, depicted as applications 216 and media content 217.

In one aspect consistent with the present disclosure, the content presentation component 102 can determine the physical context 108 or the user context 110 of the communication device 100 by performing user characterization or identification (block 218). For example, the content presentation component 102 can biometrically detect, depicted at 220, whether the user or another user is using the communication device 100. For example, the content presentation component 102 detects hand size, detects a key stroke timing pattern, detects a facial pattern, or detects a speech pattern. Alternatively or in addition, usage correlation 222 can indicate user identity. For example, current user calls a particular number or texts a particular contact that correlates with a known primary user. Alternatively or in addition, usage duration 224 can characterize a user. For example, the user could have used a particular content item 214 for a relatively short period of time, indicating novice ability, or conversely a relatively long period of time, indicating expertise. Alternatively or in addition, a transaction history 226 can characterize a user based on what content items have been purchased.

The physical context 108 can be related to a temporary or permanent physical limitation 228. In one aspect consistent with the present innovation, the content presentation component 102 can determine the temporary or permanent physical limitation 228 of the communication device 100 by at least one of a low power state 230, a low channel capacity 232, a type of serving radio access technology 234, and/or a low amount of memory storage 236.

In one aspect consistent with the present disclosure, the content presentation component 102 can determine a permanent physical constraint of a communication device carried by a user that limits appropriate content items to a subset of available content items 214. For example, the permanent physical constraint can be related to a user interface (UI) 238, such as at least one of a keypad configuration, a touch screen, and/or a size of a display.

In one aspect consistent with the present disclosure, the sensor(s) 130 can detect the context attributable to a user 240 as a location or proximity characteristic 242 from the sensed input at the communication device 100 by determining a location 244 of the communication device 100.

In one aspect consistent with the present disclosure, the content presentation component 102 can determine proximity 246, 248, 250 of a place (e.g., store, venue, etc.) 252, 254, 256 associated with a content item 214.

In one aspect consistent with the present disclosure, the content presentation component 102 can determine that the location resides within an area (e.g., legal limit) 258 that precludes a transaction related to a content item 214.

In one aspect consistent with the present disclosure, the sensor(s) 130 can detect the context attributable to the user from the sensed input at the communication device by detecting a motion imparted to the communication device 100.

In one aspect consistent with the present innovation, the content presentation component 102 can infer a user activity 260 selected from a group consisting of running/walking 262, sitting/idle/sleeping 264, boating or flying 266, riding/driving 268 or recreating/exercising 270, and from the detected motion imparted to the communication device 100.

In one aspect consistent with the present disclosure, the user interface 106 can detect the context attributable to the user from the sensed input at the communication device 100 (e.g., user data 272 for cross referencing). For example, the user data can be selected one of a group consisting of stored contacts 274, calendar events 276, retrieved destination directions 278, and called telephone numbers or message recipients 280.

In one aspect consistent with the present disclosure, the content presentation component 102 can determine a local time 282 of the communication device 100 that correlates with the content item 214.

In one aspect consistent with the present disclosure, the content presentation component 102 can detect the context attributable to the user from the sensed input at the communication device 100 by detecting a social association 284 of the user. In one aspect consistent with the present disclosure, the content presentation component 102 can detect the social association 284 of the user by determining at least one of a plurality of content items 286 associated with a stored contact 274 of the user, demographic inputs 288 selected by the user, context inherent in a text input 290 by the user, and/or a group membership 292 selected by the user.

It should be appreciated with the benefit of the present disclosure that the content item(s) 214 can be a selected from various types and combinations of application content items (“app”) 216 and media content 217. Further that media content 217 can comprise various digital formats, either singularly or in multimedia compositions, of video, audio, image, textual including Braille, etc, to include music, ringtones, ring back tones, videos, electronic books (“eBooks”), and advertisements for or information about physical goods and services.

In addition, the term application as used herein refers to computer software program in general and can further encompass data, configuration settings, etc., used by the computer software program. Examples include utilities such as e-mail, Short Message Service (SMS) text utility, chat interface, web browsers, calculators, viewers, media players, games, etc. In an exemplary aspect, application can refer to software that is suitable for use on a communication device, especially to being downloaded via a Wireless Local Access Network (WLAN) or Wireless Wide Area Network (WWAN).

For clarity, examples herein denote applications that are locally stored on user equipment, communication devices, handset, access terminals, etc. However, implementations can encompass applications that are remotely stored. Similarly, for clarity distributing of the applications to the communication devices can be described as being wirelessly downloaded from a WWAN or WLAN or P2P. However, implementations can include wired distribution, manual insertion of non-transitory computer readable storage medium, and unlocking a previously installed software object.

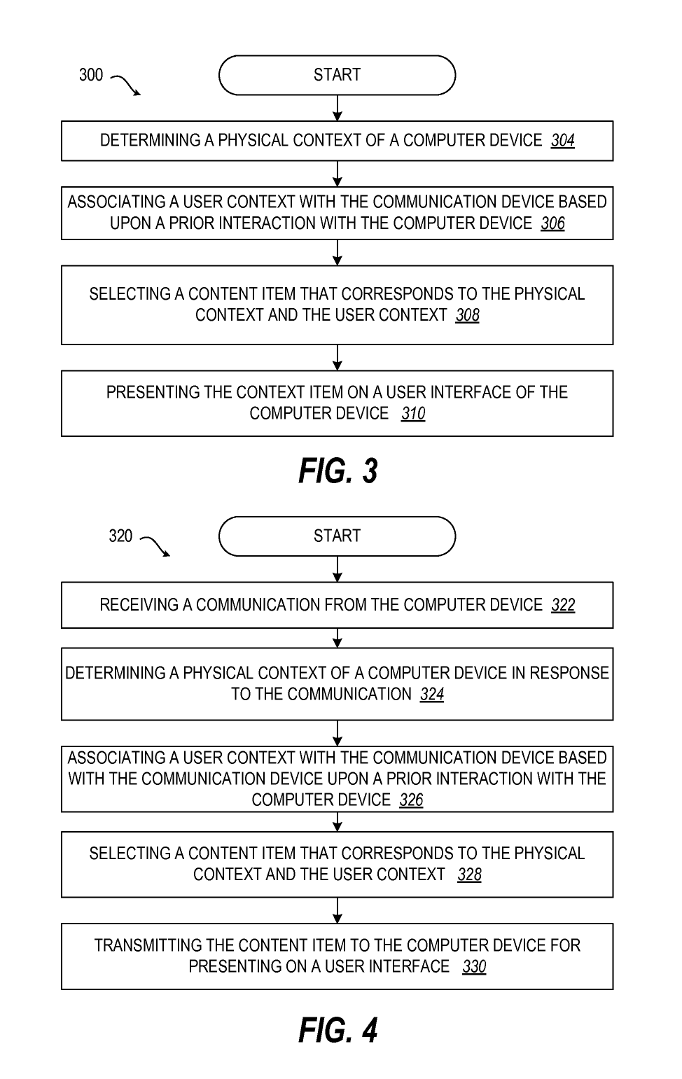

In FIG. 3, a methodology 300 is depicted for presenting individualized content on a communication device. A communication device determines its physical context (block 304). The communication device associates a user context based upon a prior interaction with the communication device (block 306). The communication device selects a content item that corresponds to the physical context and the user context (block 308). The communication device presents the content item on a user interface of the communication device (block 310).

In one aspect, determining the physical context of the communication device further comprises biometrically detecting if the communication device is in use, such as by detecting at least one of a hand size, a key stroke timing pattern, a facial pattern, and/or a speech pattern.

In another aspect, determining the physical context of the communication device further comprises determining at least one of a power state, a channel capacity, a type of serving radio access technology, and/or an amount of memory storage.

In an additional aspect, determining the physical context of the communication device further comprises determining a current location of the communication device, such as by determining proximity of a place associated with the content item. Alternatively, determining the current location of the communication device further comprises determining that the current location is within an area that precludes a transaction related to the content item.

In a further aspect, determining the physical context of the communication device further comprises detecting a motion imparted to the communication device, such as by inferring a user activity selected from a group consisting of walking, running, sitting, sleeping, boating, riding, driving, and flying.

In yet another aspect, associating the user context based upon the prior interaction with the communication device further comprises detecting at least one of a stored contact, a called telephone number, a message recipient, a retrieved destination direction, and/or a calendar event.

In yet an additional aspect, determining the physical context of the communication device further comprises determining a current location of the communication device. Selecting a content item that corresponds to the physical context and the user context further comprises determining proximity to a place of interest associated with the user context.

In yet a further aspect, determining the physical context of the communication device further comprises determining a local time for the communication device that correlates with the content item.

In one aspect, associating the user context based upon the prior interaction with the communication device further comprises detecting a social association of the user. For example, the social association of the user can be by determining at least one of a plurality of content items associated with a contact of the user, demographic inputs selected by the user, an inherent context based on a text input by the user, and/or a group membership selected by the user.

In another aspect, determining the physical context and associating the user context, and selecting the content item further comprises reporting status information from the communication device to a remote node to prompt remote selection of the content item; and obtaining the content item from the remote node for presenting on the user interface.

In an additional aspect, determining the physical context and associating the user context, and selecting the content item further comprises tracking the physical context and the user context on the communication device, and selecting the content item by a content presentation component on the communication device.

In a further aspect, determining the physical context of the communication device further comprises determining a temporary physical context of the communication device and a permanent physical constraint of the communication device. For example, determining the permanent physical constraint can further comprise determining at least one of a keypad configuration, a touch screen type input mechanism, and/or a size of a display.

In FIG. 4, a methodology 320 is depicted for suggesting individualized content for a communication device. A network device receives a communication from the communication device (block 322). The network device determines a physical context of a communication device in response to the communication (block 324). The network device associates a user context based upon a prior interaction with the communication device (block 326). The network device selects a content item that corresponds to the physical context and the user context (block 328). The network device transmits the content item to the communication device for presenting on a user interface (block 330).

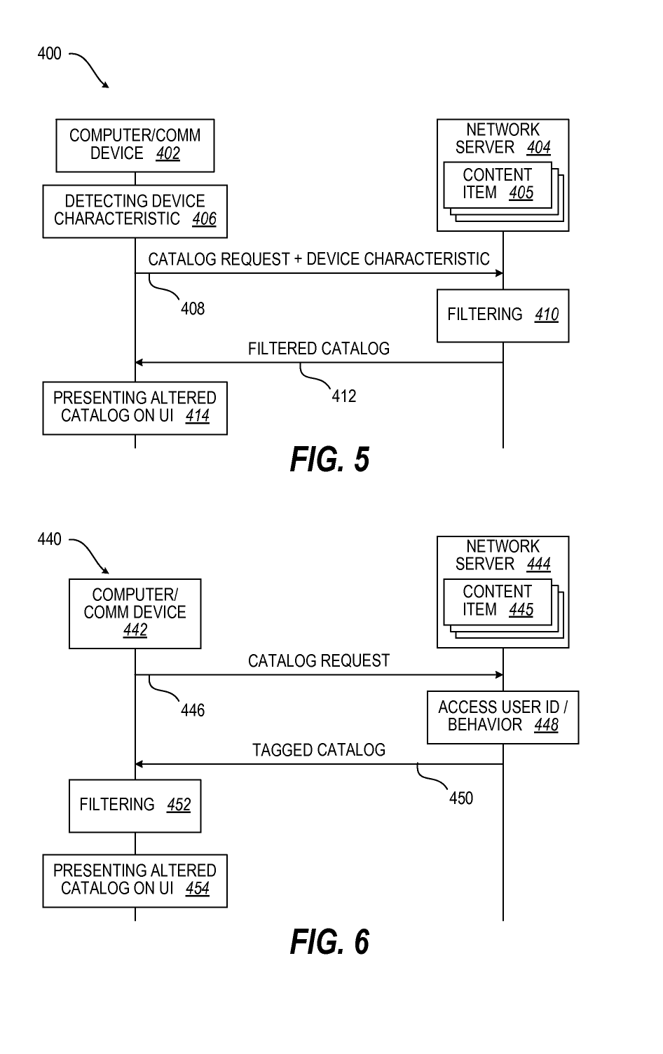

In FIG. 5, in one aspect, a methodology 400 is depicted for presenting individualized content is performed in a distributed manner between a communication device 402 and a network server 404 that contains a plurality of content items 405. The communication device detects a device characteristic (block 406). In response, the communication device 402 transmits a catalog request and transmits data regarding the device characteristic as depicted at 408 to the network server 404. The network server 404 performs filtering of the content items 405 (block 410). The network server 404 transmits a filtered catalog as depicted at 412. The catalog can comprise one or more links to or advertisements for content items. The communication device 402 presents the filtered catalog on a UI (block 414). The presentation can be altered according to context. For example, an inferred activity of the user can warrant varying the amount of detail presented or the type of presentation. For example, determining that the user is driving can warrant an audio alert of being near to a business of interest. Determining that the user is closely interacting with the communication device can prompt a small banner advertisement that does not intrude upon an active part of a display.

In FIG. 6, in one aspect, a methodology 440 is depicted for presenting individualized content is performed in a distributed manner between a communication device 442 and a network server 444 that contains a plurality of content items 445. The communication device 442 transmits a catalog request as depicted at 446 to the network server 444. The network server 444 accesses user identification and behavior data (block 448). The network server 444 transmits a tagged catalog as depicted at 450. The tags allow characterization of content items in the catalog. The communication device 442 performs filtering of the tagged catalog (block 452). The communication device 442 presents the filtered catalog on a UI (block 454). The presentation can be altered according to context.

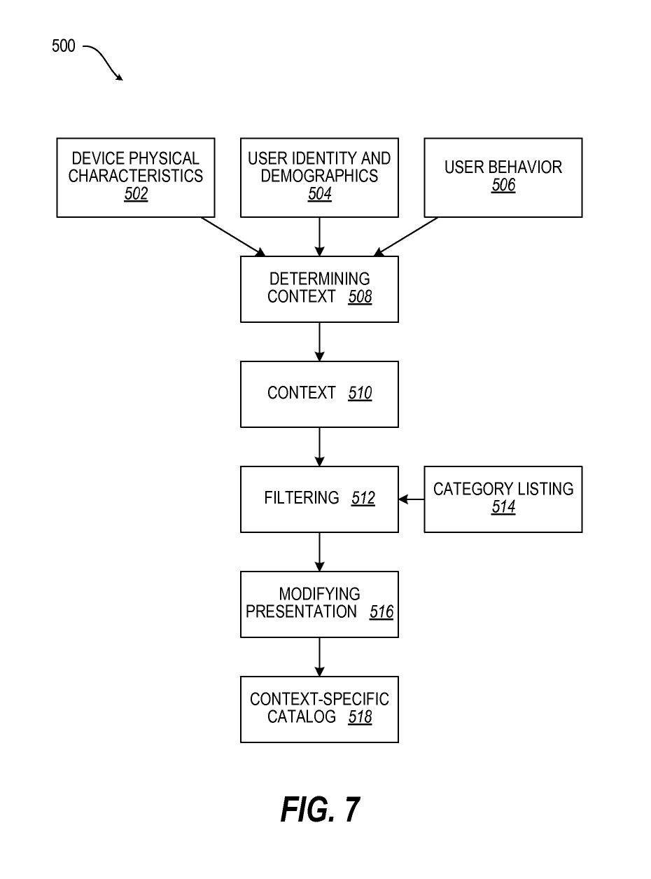

In FIG. 7, a methodology 500 is depicted for presenting individualized content on a communication device according to context. Inputs are accessed or determined, depicted as device physical characteristics (block 502), user identity and demographics (block 504), and user behavior (block 506). Context is determined from these inputs (block 508). The resulting context (block 510) is used to filter (block 512) applicable entries in a category listing (block 514). The presentation of the filtered categories can further be modified (e.g., sorting, segregating, categorizing, etc.). For example, the more applicable content items or categories can be made prominent in a resulting context-specific catalog (block 518).

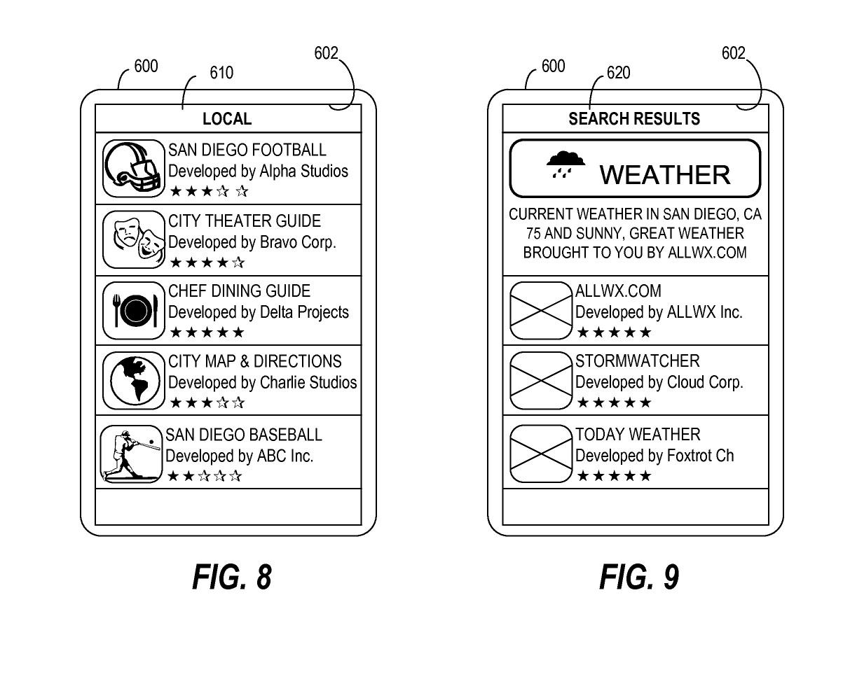

In FIG. 8, a communication device 600 has a user interface 602 that incorporates context for identifying who, what, where, how and why of a given situation. In a first aspect, the context of location (i.e., the where) is obtained through Global Positioning System (GPS) technology. Thereby content items can be presented such a local catalog 610. A mobile shopping experience can be tailored to meet a user's unique location based needs. For example, when a request is made from a communication device or handset to load the store, the user's current location can also be passed along with the other header parameters. The information can then be used to enhance the user's mobile shopping experience by:

(a) Creating a dynamic local category;

(b) Enhancing search results; and

(c) Promoting travel guides with tailored price plans, etc.

In FIG. 9, the communication device 600 has the user interface 602 presenting a search results catalog 620 for weather related content items enhanced by location information.

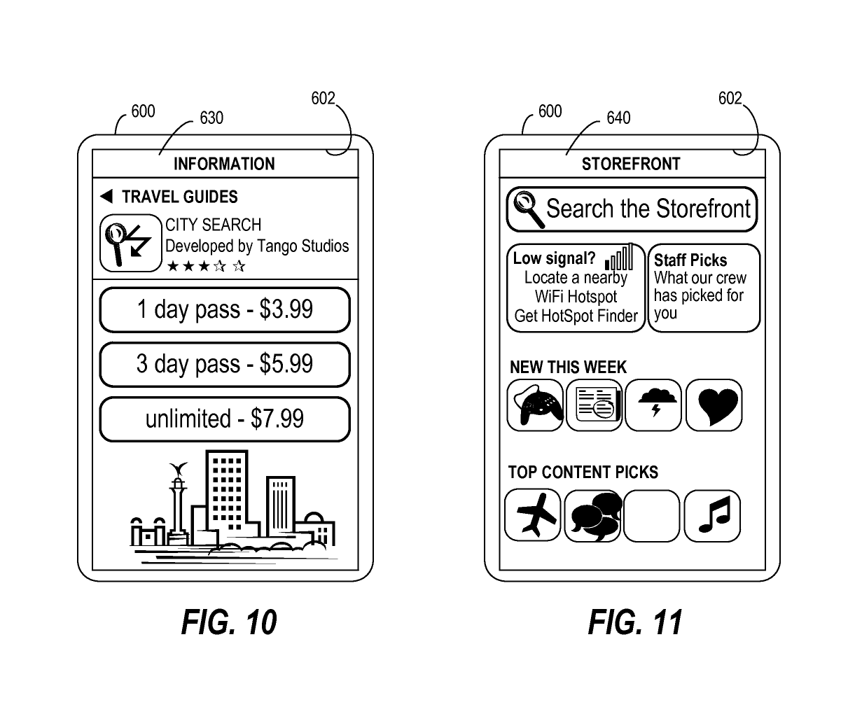

In FIG. 10, the communication device 600 has the user interface 602 presenting a travel guide catalog 630 enhanced by location information.

In FIG. 11, the communication device 600 has the user interface 602 presenting a search results catalog 640 enhanced by location information. In one aspect, other contexts can also be leveraged to promote relevant content such as signal strength by suggesting applications and tools appropriate for low signal strength situation.

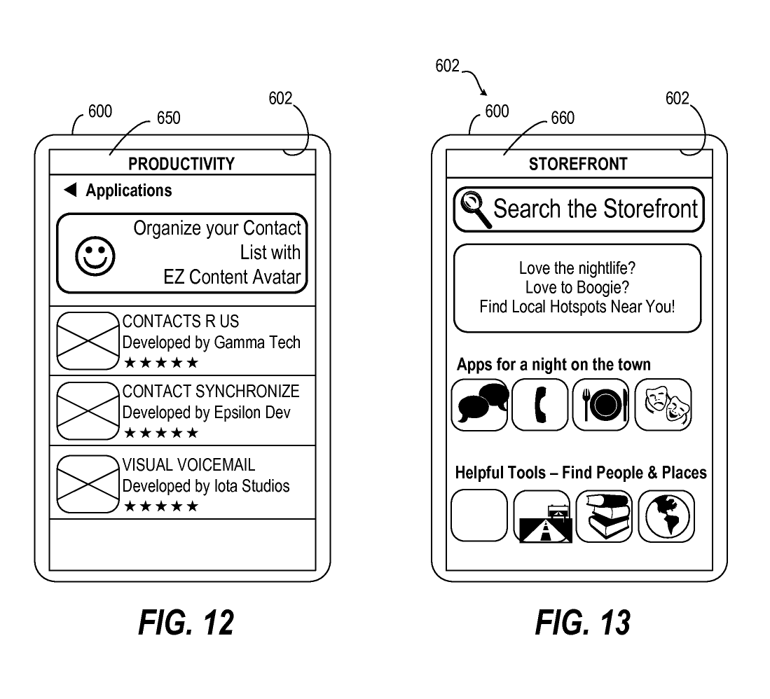

In FIG. 12, the communication device 600 has the user interface 602 presenting a productivity catalog 650 provides contact list status.

In FIG. 13, the communication device 600 has the user interface 602 presenting a storefront catalog 660 that highlights timely content (e.g., time and day).

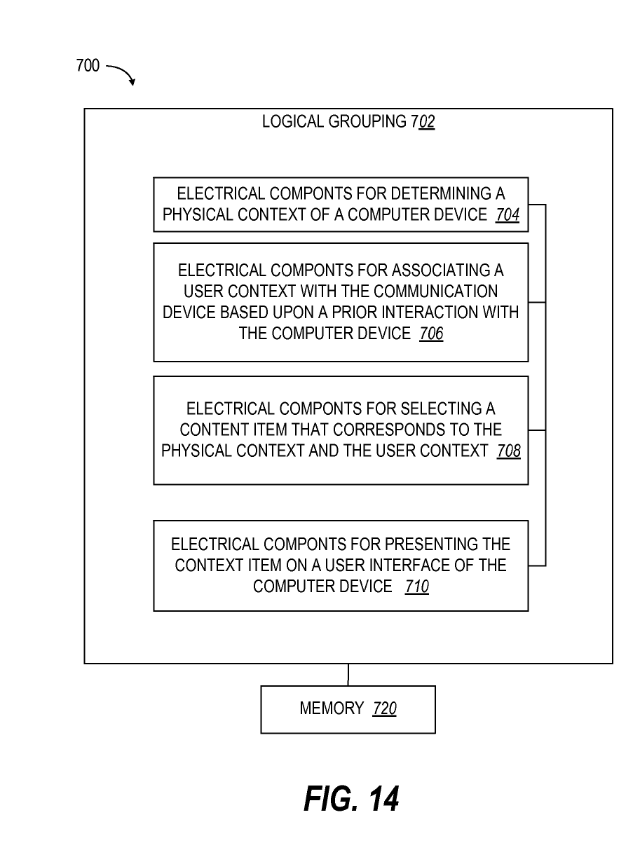

With reference to FIG. 14, illustrated is a system 700 for presenting individualized content on a communication device. For example, system 700 can reside at least partially within a communication device or user equipment (UE). It is to be appreciated that system 700 is represented as including functional blocks, which can be functional blocks that represent functions implemented by a computing platform, processor, software, or combination thereof (e.g., firmware). System 700 includes a logical grouping 702 of electrical components that can act in conjunction. For instance, logical grouping 702 can include an electrical component 704 for determining a physical context of a communication device. Moreover, logical grouping 702 can include an electrical component 706 for associating a user context with the communication device based upon a prior interaction with the communication device. In addition, logical grouping 702 can include an electrical component 708 for selecting a content item that corresponds to the physical context and the user context. Furthermore, logical grouping 702 can include an electrical component 710 for presenting the content item on a user interface of the communication device. Additionally, system 700 can include a memory 720 that retains instructions for executing functions associated with electrical components 704-710. While shown as being external to memory 720, it is to be understood that one or more of electrical components 704-710 can exist within memory 720.

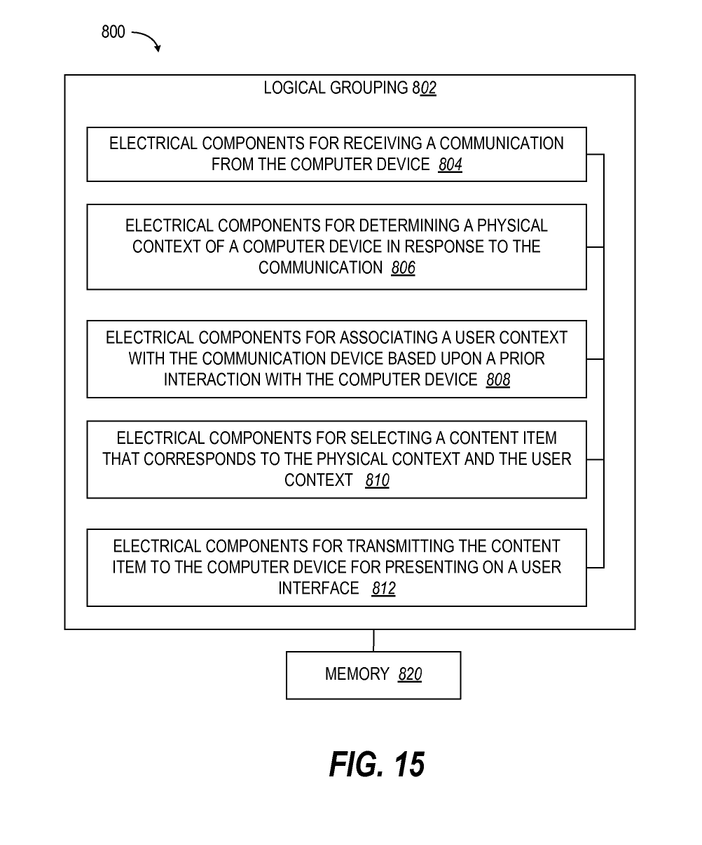

With reference to FIG. 15, illustrated is a system 800 for suggesting individualized content for a communication device. For example, system 800 can reside at least partially within a network entity (e.g., evolved base node). It is to be appreciated that system 800 is represented as including functional blocks, which can be functional blocks that represent functions implemented by a computing platform, processor, software, or combination thereof (e.g., firmware). System 800 includes a logical grouping 802 of electrical components that can act in conjunction. For instance, logical grouping 802 can include an electrical component 804 for receiving a communication from the communication device. Moreover, logical grouping 802 can include an electrical component 806 for determining a physical context of a communication device in response to the communication. In addition, logical grouping 802 can include an electrical component 808 for associating a user context with the communication device based upon a prior interaction with the communication device. Furthermore, logical grouping 802 can include an electrical component 810 for selecting a content item that corresponds to the physical context and the user context. For instance, logical grouping 802 can include an electrical component 812 for transmitting the content item to the communication device for presenting on a user interface. Additionally, system 800 can include a memory 820 that retains instructions for executing functions associated with electrical components 804-812. While shown as being external to memory 820, it is to be understood that one or more of electrical components 804-812 can exist within memory 820.

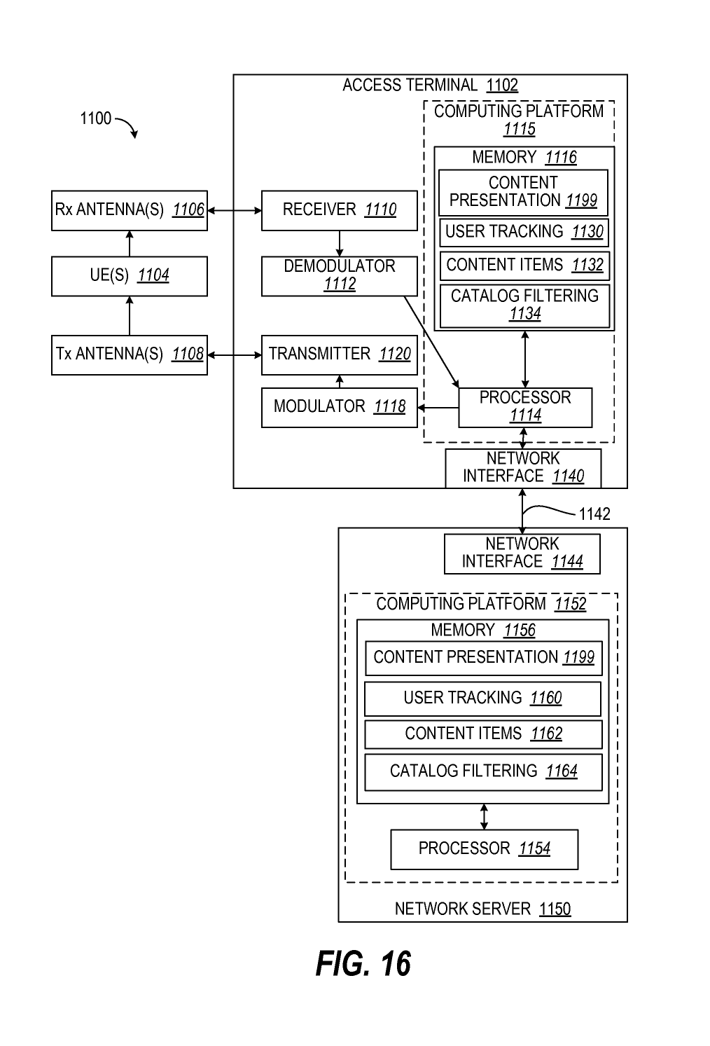

FIG. 16 is a block diagram of a system 1100 that can be utilized to implement various aspects of the functionality described herein. In one example, system 1100 includes an access terminal (AT), base station or Node B 1102. As illustrated, AT 1102 can receive signal(s) from one or more UEs 1104 via one or more receive (Rx) antennas 1106 and transmit to the one or more UEs 1104 via one or more transmit (Tx) antennas 1108. Additionally, Node B 1102 can comprise a receiver 1110 that receives information from receive antenna(s) 1106. In one example, the receiver 1110 can be operatively associated with a demodulator 1112 that demodulates received information. Demodulated symbols can then be analyzed by a processor 1114. Processor 1114 can be coupled to memory 1116, which can store information related to code clusters, access terminal assignments, lookup tables related thereto, unique scrambling sequences, and/or other suitable types of information. In one example, Node B 1102 can also include a modulator 1118 that can multiplex a signal for transmission by a transmitter 1120 through transmit antenna(s) 1108.

A content presentation component 1199, either autonomous, distributed, or distributed with an autonomous capability, is implemented is implemented in the system 1100.

In one aspect, the Node B 1102 can provide contextual catalogs or assist in providing contextual catalogs to UEs 1104. To that end, the memory can comprise a user tracking component 1130, content items 1132, and a catalog filtering component 1134.

In another aspect, the network assistance to contextual catalogs can be distributed, depicted as a network interface 1140 communicating across a network 1142 to network interface 1144 of a network server 1150. A computing platform 1152 of the network server 1150 has at least one processor 1154 for accessing a memory 1156 to perform a user tracking component 1160, a content items repository 1162 and a catalog filtering component 1164.

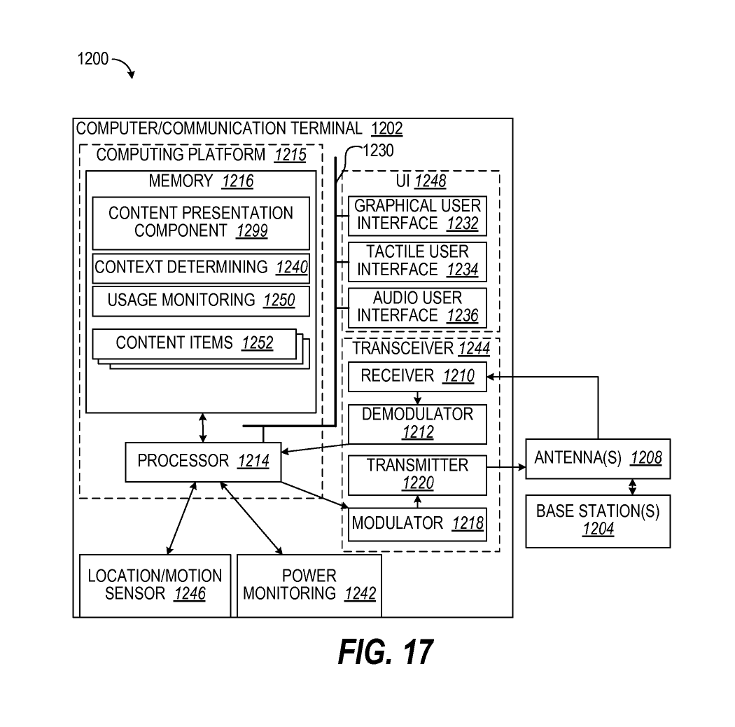

FIG. 17 is a block diagram of another system 1200 that can be utilized to implement various aspects of the functionality described herein. In one example, system 1200 includes a mobile terminal 1202. As illustrated, mobile terminal 1202 can receive signal(s) from one or more base stations 1204 and transmit to the one or more base stations 1204 via one or more antennas 1208. Additionally, mobile terminal 1202 can comprise a receiver 1210 that receives information from antenna(s) 1208. In one example, receiver 1210 can be operatively associated with a demodulator 1212 that demodulates received information. Demodulated symbols can then be analyzed by a processor 1214. Processor 1214 can be coupled to memory 1216, which can store data and/or program codes related to mobile terminal 1202. Additionally, mobile terminal 1202 can employ processor 1214 to perform methodologies described herein. Mobile terminal 1202 can also include a modulator 1218 that can multiplex a signal for transmission by a transmitter 1220 through antenna(s) 1208.

A content presentation component 1299, either autonomous, distributed, or distributed with an autonomous capability, is implemented is implemented at least in part in the system 1200.

For instance, a context determining component 1240 residing in memory 1216 executed by the processor 1214 determines a varying or temporary operating constraint, such as experienced by capacity of the memory 1216, sensing by a power monitoring component 1242, and channel monitoring by a transceiver 1244. The context determining component 1240 can further determine a context of the user of the mobile terminal 1202 based upon readings by a location or motion sensor(s) 1246, user interactions with user interface 1248, usage monitoring by a component 1250 for provisioned content items 1252, or remotely monitored data associated with the user received from the base station(s) 1204.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a user terminal In the alternative, the processor and the storage medium may reside as discrete components in a user terminal

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for presenting individualized content, comprising:
determining a physical context of a communication device;
associating a user context with the communication device based upon a prior interaction with the communication device;
selecting a content item that corresponds to the physical context and the user context; and
presenting the content item on a user interface of the communication device.

2. The method of claim 1, wherein determining the physical context of the communication device further comprises biometrically detecting if the communication device is in use.

3. The method of claim 2, wherein biometrically detecting if the communication device is in use further comprises detecting at least one of a hand size, a key stroke timing pattern, a facial pattern, or a speech pattern.

4. The method of claim 1, wherein determining the physical context of the communication device further comprises determining at least one of a power state, a channel capacity, a type of serving radio access technology, or an amount of memory storage.

5. The method of claim 1, wherein determining the physical context of the communication device further comprises determining a current location of the communication device.

6. The method of claim 5, wherein determining the current location of the communication device further comprises determining proximity of a place associated with the content item.

7. The method of claim 5, wherein determining the current location of the communication device further comprises determining that the current location is within an area that precludes a transaction related to the content item.

8. The method of claim 1, wherein determining the physical context of the communication device further comprises detecting a motion imparted to the communication device.

9. The method of claim 8, wherein detecting the motion imparted to the communication device further comprises inferring a user activity selected from a group consisting of walking, running, sitting, sleeping, boating, riding, driving, and flying.

10. The method of claim 1, wherein associating the user context based upon the prior interaction with the communication device further comprises detecting at least one of a stored contact, a called telephone number, a message recipient, a retrieved destination direction, or a calendar event.

11. The method of claim 1, wherein determining the physical context of the communication device further comprises determining a current location of the communication device, and wherein selecting a content item that corresponds to the physical context and the user context further comprises determining proximity to a place of interest associated with the user context.

12. The method of claim 1, wherein determining the physical context of the communication device further comprises determining a local time for the communication device that correlates with the content item.

13. The method of claim 1, wherein associating the user context based upon the prior interaction with the communication device further comprises detecting a social association of a user.

14. The method of claim 13, wherein detecting the social association of the user further comprises determining at least one of a plurality of content items associated with a contact of the user, demographic inputs selected by the user, an inherent context based on a text input by the user, or a group membership selected by the user.

15. The method of claim 1, wherein determining the physical context and associating the user context, and selecting the content item further comprises:
reporting status information from the communication device to a remote node to prompt remote selection of the content item; and
obtaining the content item from the remote node for presenting on the user interface.

16. The method of claim 1, wherein determining the physical context and associating the user context, and selecting the content item further comprises:
tracking the physical context and the user context on the communication device; and
selecting the content item by a content presentation component on the communication device.

17. The method of claim 1, wherein determining the physical context of the communication device further comprises determining a temporary physical context of the communication device and a permanent physical constraint of the communication device.

18. The method of claim 17, wherein determining the permanent physical constraint further comprises determining at least one of a keypad configuration, a touch screen type input mechanism, or a size of a display.

19. At least one processor for presenting individualized content, comprising:
a first module for determining a physical context of a communication device;
a second module for associating a user context with the communication device based upon a prior interaction with the communication device;
a third module for selecting a content item that corresponds to the physical context and the user context; and
a fourth module for presenting the content item on a user interface of the communication device.

20. A computer program product for presenting individualized content, comprising:
a non-transitory computer-readable medium for storing sets of instructions comprising:
at least one instruction for causing a computer to determine a physical context of a communication device;
at least one instruction for causing the computer to associate a user context with the communication device based upon a prior interaction with the communication device;
at least one instruction for causing the computer to select a content item that corresponds to the physical context and the user context; and
at least one instruction for causing the computer to present the content item on a user interface of the communication device.

21. An apparatus for presenting individualized content, comprising:
means for determining a physical context of a communication device;
means for associating a user context with the communication device based upon a prior interaction with the communication device;
means for selecting a content item that corresponds to the physical context and the user context; and
means for presenting the content item on a user interface of the communication device.

22. An apparatus for presenting individualized content, comprising:
a content presentation component for determining a physical context of a communication device;
the content presentation component further for associating a user context with the communication device based upon a prior interaction with the communication device;
the content presentation component further for selecting a content item that corresponds to the physical context and the user context; and
a user interface of the communication device for presenting the content item.

23. The apparatus of claim 22, wherein the content presentation component is further for determining the physical context of the communication device by biometrically detecting if the communication device is in use.

24. The apparatus of claim 23, wherein the content presentation component is further for biometrically detecting if the communication device is in use by detecting at least one of a hand size, a key stroke timing pattern, a facial pattern, or a speech pattern.

25. The apparatus of claim 22, wherein the content presentation component is further for determining the physical context of the communication device by determining at least one of a power state, a channel capacity, a type of serving radio access technology, or an amount of memory storage.

26. The apparatus of claim 22, wherein the content presentation component is further for determining the physical context of the communication device by determining a current location of the communication device.

27. The apparatus of claim 26, wherein the content presentation component is further for determining the current location of the communication device by determining proximity of a place associated with the content item.

28. The apparatus of claim 26, wherein the content presentation component is further for determining the current location of the communication device by determining that the current location is within an area that precludes a transaction related to the content item.

29. The apparatus of claim 22, wherein the content presentation component is further for determining the physical context of the communication device by detecting a motion imparted to the communication device.

30. The apparatus of claim 29, wherein the content presentation component is further for detecting the motion imparted to the communication device by inferring a user activity selected from a group consisting of walking, running, sitting, sleeping, boating, riding, driving, and flying.

31. The apparatus of claim 22, wherein the content presentation component is further for associating the user context based upon the prior interaction with the communication device by detecting at least one of a stored contact, a called telephone number, a message recipient, a retrieved destination direction, or a calendar event.

32. The apparatus of claim 31, wherein the content presentation component is further for determining the physical context of the communication device by determining a current location of the communication device, and wherein selecting a content item that corresponds to the physical context and the user context further comprises determining proximity to a place of interest associated with the user context.

33. The apparatus of claim 22, wherein the content presentation component is further for determining the physical context of the communication device by determining a local time for the communication device that correlates with the content item.

34. The apparatus of claim 22, wherein the content presentation component is further for associating the user context based upon the prior interaction with the communication device by detecting a social association of a user.

35. The apparatus of claim 34, wherein the content presentation component is further for detecting the social association of the user by determining at least one of a plurality of content items associated with a contact of the user, demographic inputs selected by the user, an inherent context based on a text input by the user, or a group membership selected by the user.

36. The apparatus of claim 22, wherein the content presentation component is further for determining the physical context and associating the user context, and selecting the content item by:
reporting status information from the communication device to a remote node to prompt remote selection of the content item; and
obtaining the content item from the remote node for presenting on the user interface.

37. The apparatus of claim 22, wherein the content presentation component is further for determining the physical context and associating the user context, and selecting the content item by:
tracking the physical context and the user context on the communication device; and
selecting the content item by a content presentation component on the communication device.

38. The apparatus of claim 22, wherein the content presentation component is further for determining the physical context of the communication device by determining a temporary physical context of the communication device and a permanent physical constraint of the communication device.

39. The apparatus of claim 38, wherein the content presentation component is further for determining the permanent physical constraint by determining at least one of a keypad configuration, a touch screen type input mechanism, or a size of a display.

40. A method for suggesting individualized content, comprising:
receiving a communication from a communication device;
determining a physical context of the communication device in response to the communication;
associating a user context with the communication device based upon a prior interaction with the communication device;
selecting a content item that corresponds to the physical context and the user context; and
transmitting the content item to the communication device for presenting on a user interface.

41. At least one processor for suggesting individualized content, comprising:
a first module for receiving a communication from a communication device;
a second module for determining a physical context of the communication device in response to the communication;
a third module for associating a user context with the communication device based upon a prior interaction with the communication device;
a fourth module for selecting a content item that corresponds to the physical context and the user context; and
a fifth module for transmitting the content item to the communication device for presenting on a user interface.

42. A computer program product for suggesting individualized content, comprising:
a non-transitory computer-readable medium storing sets of instructions comprising:
at least one instruction for causing a computer to receive a communication from a communication device;
at least one instruction for causing the computer to determine a physical context of the communication device in response to the communication;
at least one instruction for causing the computer to associate a user context with the communication device based upon a prior interaction with the communication device;
at least one instruction for causing the computer to select a content item that corresponds to the physical context and the user context; and
at least one instruction for causing the computer to transmit the content item to the communication device for presenting on a user interface.

43. An apparatus for suggesting individualized content, comprising:
means for receiving a communication from a communication device;
means for determining a physical context of the communication device in response to the communication;
means for associating a user context with the communication device based upon a prior interaction with the communication device;
means for selecting a content item that corresponds to the physical context and the user context; and
means for transmitting the content item to the communication device for presenting on a user interface.

44. An apparatus for suggesting individualized content, comprising:
a network interface for receiving a communication from a communication device;
a content presentation component for determining a physical context of the communication device in response to the communication, for associating a user context with the communication device based upon a prior interaction with the communication device, and for selecting a content item that corresponds to the physical context and the user context; and
the network interface further for transmitting the content item to the communication device for presenting on a user interface.
